(19) United States
(12) Patent Application Publication
(10) Pub. No.: US 2015/0002648 A1
(43) Pub. Date: Jan. 1, 2015

(54) Measuring Apparatus Capable Of Measuring A Continuous Motional State

(71) Applicant: CASIO COMPUTER CO., LTD, Shibuya-ku (JP)

(72) Inventor: Yoshihiro KAWAMURA, Fussa-shi (JP)

(21) Appl. No.: 14/318,134

(22) Filed: Jun. 27, 2014

(30) Foreign Application Priority Data
Jun. 28, 2013 (JP) 2013-136177

(51) Int. Cl. G06K 9/00; H04N 7/18

(52) U.S. Cl. CPC G06K 9/00335; H04N 7/18
USPC 348/77

(57) ABSTRACT

A measuring apparatus includes an image acquiring unit configured to sequentially acquire images, a position detecting unit configured to detect positions of a particular body part of the person in the images sequentially acquired by the image acquiring unit, and a measuring unit configured to measure a continuous motional state of the person based on the detected positions of the particular body part.

### BACKGROUND

1. Technical Field

The present invention relates to an apparatus, a method, and a recording medium for measuring a continuous motional state of a person.

2. Related Art

For example, JP 2009-53911 A discloses a technique to measure a continuous motional state of a person, such as a pitch of the person during running motion, according to an acceleration value detected along with the running motion of the person by installing an acceleration sensor on the person.

### SUMMARY

To achieve an object, a measuring apparatus of one aspect of the present invention includes: an image acquiring unit configured to sequentially acquire images, a position detecting unit configured to detect positions of a particular body part of a person in the images sequentially acquired by the image acquiring unit, and a measu 0 unit configured to measure a continuous motional state of the person based on the detected positions of the particular body part

Further, to achieve the object, a method for measuring a continuous motional state of a person of one aspect of the present invention includes the steps of: sequentially acquiring images; detecting positions of a particular body part of the person in the respective acquired images; and measuring the continuous motional state of the person based on the detected positions of the particular body part of the person.

Further, to achieve the object, a storage medium of one aspect of the present invention is a non-volatile recording medium storing a computer-readable program for causing a computer to execute: a procedure to sequentially acquire images, a procedure to detect positions of a particular body part of a person in the respective acquired images, and a procedure to measure a continuous motional state of the person based on the detected positions of the particular body part.

### BRIEF DESCRIPTION OF THE DRAWINGS

FIG. 1 is a view illustrating an exemplary health appliance to which a measuring apparatus according to an embodiment of the present invention is applied;

FIG. 2 is a block diagram illustrating a structure of the measuring apparatus according to the embodiment of the present invention;

FIG. 3 is a flowchart illustrating an operation of the measuring apparatus according to the embodiment of the present invention;

FIGS. 4A to 4F are explanatory views cited to explain a principle of measuring a motional state of the measuring apparatus according to the embodiment of the present invention;

FIGS. 5A and 5B are graphs illustrating an example of an output form of the measuring apparatus according to the embodiment of the present invention;

FIG. 6 is a graph illustrating another example of the output form of the measuring apparatus according to the embodiment of the present invention; and

FIG. 7 is an explanatory view cited to explain a cooperative operation with a health appliance to which the measuring apparatus according to the embodiment of the present invention is applied.

### DETAILED DESCRIPTION

In the following, an embodiment of the present invention (hereinafter referred to as the present embodiment) will be described in detail by referring to the accompanying drawings. It is noted that the same elements will be indicated by the same reference numerals throughout the description of the present embodiment.

(Structure of Embodiment)

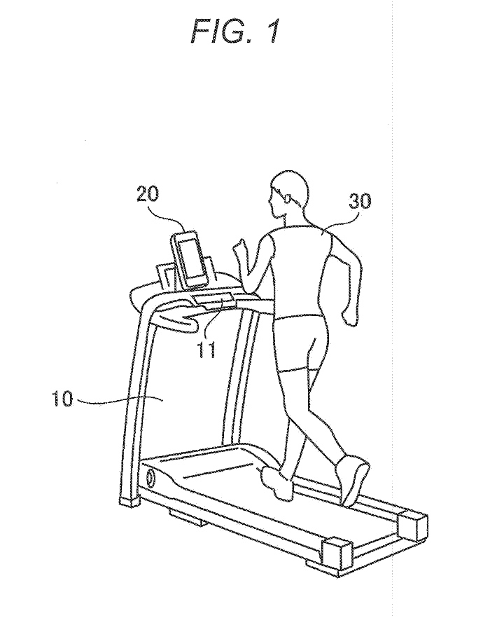

As illustrated in FIG. 1, a measuring apparatus 20 of the present embodiment is applicable, for example, to a treadmill 10. The treadmill 10 is a health appliance used indoors for exercise such as running and walking. The treadmill 10 is configured to adjust speed by moving a belt-conveyor-like step board using power from a motor. The treadmill 10 displays data of inclination adjustment, a running distance, time, consumed calories, etc.

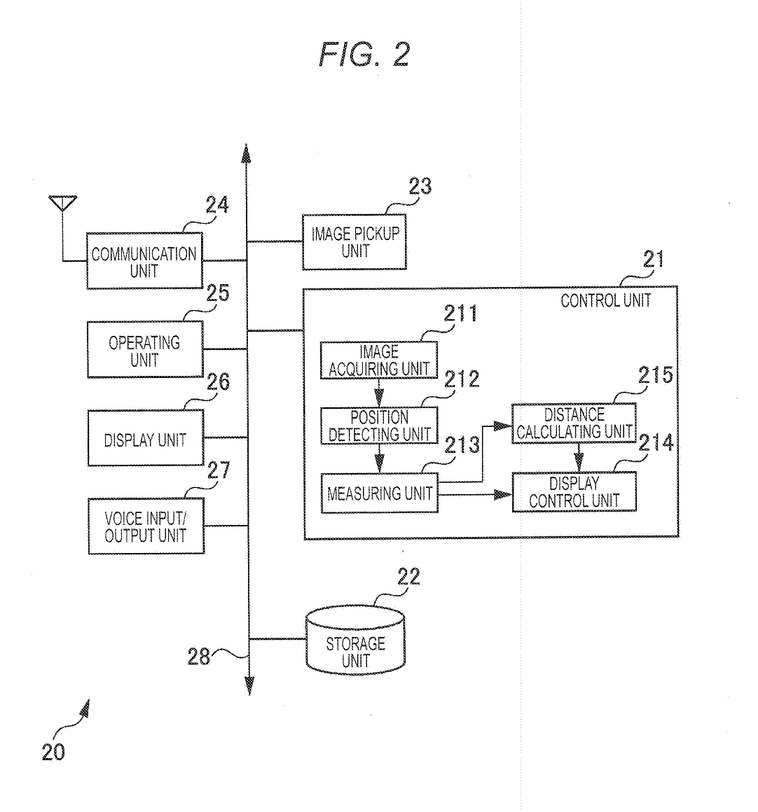

A measuring apparatus 20 of the present embodiment may be realized, for example, by a mobile phone which is mounted at a position where the face of a person 30, who has been running or walking on the treadmill 10, can be monitored by an in-camera (illustrated as an image pickup unit 23 in FIG. 2 described below). The measuring apparatus 20 is herein used while standing against a portion of the treadmill 10 near an operating panel 11. The measuring apparatus 20 sequentially acquires images including the face of the person 30 who is regarded as a subject, detects the position of the face of the person 30 in the acquired images, and measures a continuous motional state of the person 30 based on the detected position of the face of the person 30 in the images. Meanwhile, the measured motional state of the person 30 is displayed on a screen, as needed, details of which will be described below.

As illustrated in FIG. 2, the measuring apparatus 20 includes a control unit 21, a storage unit 22, an image pickup unit 23, a communication unit 24, an operating unit 25, a display unit 26, and a voice input/output unit 27. These constituent elements are connected with each other via a bus 28 formed by a plurality of address, data, and control lines.

The image pickup unit 23 is equivalent to the above-mentioned in-camera capable of capturing an image of the subject. The image pickup unit 23 includes an optical lens, a stop, and an image pickup element and forms an image of the subject by focusing it on the image pickup element through the optical lens and the stop. The stop is arranged between the optical lens and the image pickup element on an imaging plane. A nearly circular opening is formed in the stop by overlaying a plurality of plates on top of each other. The image pickup element is configured as an image sensor such as a CCD or a CMOS. In addition to the optical lens, the stop, and the image pickup element, the image pickup unit 23 also includes an optical system driving unit, an illuminating strobe, an analogue processing circuit, a signal processing circuit, etc. The stop and the image pickup element are movable in parallel with a direction vertical to an optical axis and connected to driving mechanisms respectively for moving the stop and the image pickup element in parallel.

The communication unit 24 receives, via a base station, a signal from a communication device other than the mobile phone, or from an information processing apparatus such as a web server connected to an Internet protocol (IP) network, which is not illustrated. The communication unit 24 amplifies and down-converts the received signal before outputting the signal to the control unit 21. At this time, the control unit 21 performs processing such as decoding processing on the input signal to obtain media information such as voices and videos included in the received signal. The communication unit 24 up-converts and amplifies the media information generated in the control unit 21 before transmitting the processed signal in a wireless manner. The signal is received by, for example, a communication device other than the mobile phone, or a web server connected to the IP network via the base station which is not illustrated. Further, the communication unit 24 may perform short-range wireless communication with the treadmill 10 to obtain therefrom data such as the number of steps, running or walking distance of the person 30, etc. measured by the treadmill 10.

The operating unit 25 includes a plurality of key switches. When each key switch is pressed down by the person 30, the operating unit 25 outputs an input operation signal indicating the pressed key switch to the control unit 21. According to the input operation signal, the control unit 21 identifies the key switch that has been pressed down among the plurality of key switches and performs an action corresponding to the pressed key switch. The operating unit 25 includes push button-type key switches, as will be described below. For example, a “measurement start button” and an “output button” are provided. In response to the input operation signal from the operating unit 25, the control unit 21 starts shooting or displays a measurement result, for example.

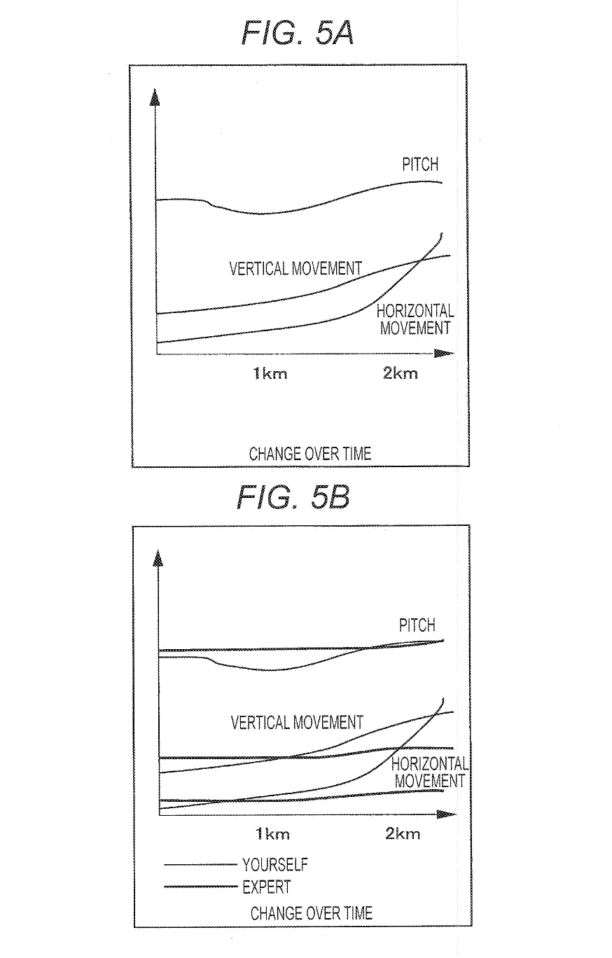

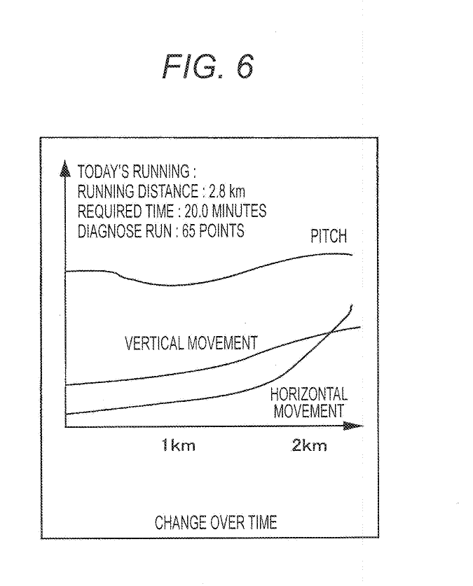

The display unit 26 displays images generated by the control unit 21, such as images (screens) illustrated in FIGS. 5A, 5B and 6. For example, a high definition liquid crystal device (LCD), an organic electro luminescence (EL) display, or an electrophoresis-type display (electronic paper) may be used as the display unit 26 to perform high-definition display of the above-mentioned images. The display unit 26 may also be formed as an electrostatic-type touch screen (touch panel) by stacking a transparent touch panel over the display surface of the display unit 26 to detect finger touch.

The voice input/output unit 27 performs processing of voice signals input from a microphone, which is not illustrated, or output from a speaker. Specifically, the voice input/output unit 27 amplifies the voice having been input from the microphone, performs an analogue-digital conversion on the amplified voice, and further performs signal processing such as coding to convert the signals into digital voice data and outputs the digital voice data to the control unit 21. Subsequently, the voice data output from the control unit 21 is subjected to processing such as decoding, digital-analogue conversion, and amplification, and converted into an analogue voice signal. The analogue voice signal is then output to a speaker.

The control unit 21 includes, for example, a microprocessor mounted thereon. The microprocessor follows a program (a motional state measuring application which will be described below) of the present embodiment stored in a predetermined region of the storage unit 22 to sequentially acquire images and to detect positions of the face of the person 30 in the acquired images. Based on the detected positions of the face of the person 30, the microprocessor measures the continuous motional state of the person 30. Therefore, a program to be executed by the control unit 21 includes, when exploded, an image acquiring unit 211 a position detecting unit 212, and a measuring unit 213. The control unit 21 may include a display control unit 214 and a distance calculating unit 215.

The image acquiring unit 211 has a function to sequentially acquire images to he captured by the image pickup unit 23 and to output the acquired images to the position detecting unit 212. The position detecting unit 212 has a function to detect positions of the face of the person 30 in the images sequentially acquired by the image acquiring unit 211 and output the detected positions to the measuring unit 213. The measuring unit 213 has a function to measure the continuous motional state of the person 30 based on the positions of the face of the person 30 having been detected by the position detecting unit 212.

The measuring unit 213 may have a function to measure, as the motional state, changes in position of the face of the person 30 in the images detected by the position detecting unit 212. The measuring unit 213 may also have a function to measure, as a notional state, a pitch number of the person 30 according to periodic changes in a vertical direction of the position of the face of the person 30 in the images. Further, the measuring unit 213 may have a function to measure a shift in position in a horizontal direction of the face of the person 30 in each image as a change in the motional state.

The display control unit 214 has a function to display, on the display unit 26, the motional state of the person 30 having been measured by the measuring unit 213. Specifically, the display control unit 214 reads, in synchronism with the display timing of the display unit 26, the display information illustrated in, for example, FIGS. 5A and 5B, having been generated by the measuring unit 213 and written in a predetermined region (VRAM region) of the storage unit 22. The display control unit 214 then outputs the read information to the display device to display in a predetermined manner. The distance calculating unit 215 has a function to calculate a distance regarding running or walking of the person. At this time, the display control unit 214 controls the display unit 26 to display the motional state relative to the distance of running or walking calculated by the distance calculating unit 215.

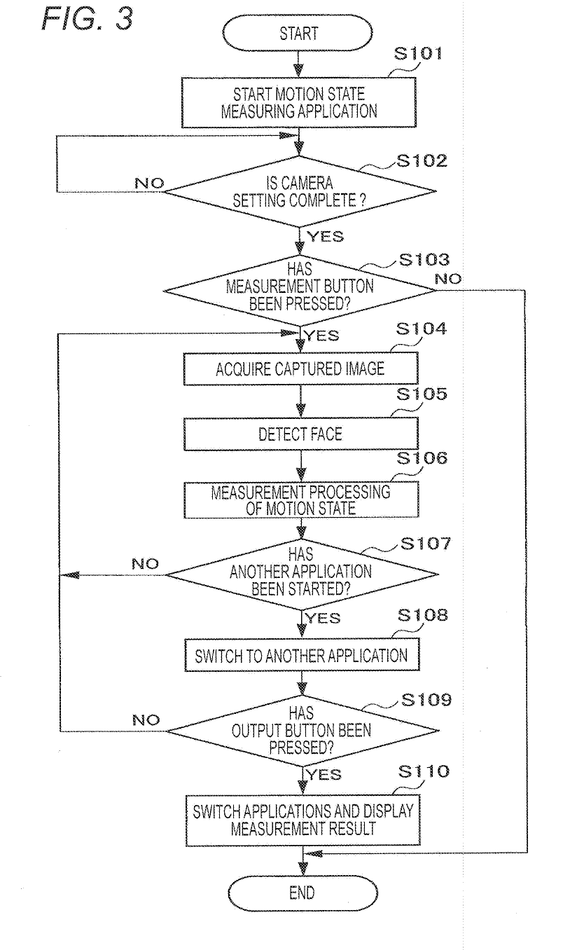

The storage unit 22 has a structure including, for example, a ROM and a flash memory. For example, the storage unit 22 is assigned with the program of the present embodiment implemented by the flowchart (processing procedure) as illustrated in FIG. 3, the VRAM region mentioned above, or a data table used in score evaluation of the motional state, which will be described below. The storage unit 22 is also assigned with an image storage region where the acquired images are stored. In addition, the storage unit 22 is assigned with a working area where data such as working data generated in the course of executing the program of the present embodiment by the control unit 21 is temporarily stored. The storage unit 22 may be configured to include, for example, a removable portable memory (recording medium), such as an SD card and an IC card.

(Operation of Embodiment)

An operation of the measuring apparatus 20 according to the present embodiment will be described below. As illustrated in FIG. 1, the measuring apparatus 20 of the present embodiment uses the in-camera of the mobile phone, for example, to continuously monitor the face part, in particular, of the person 30 who has been running or walking on the treadmill 10 The measuring apparatus 20 detects periodic motions of the face of the person 30 using a face detecting function by image processing, to thereby perform measurement of the number of steps. In executing, the measurement processing, the current state of running or walking is displayed on the screen of the mobile phone. Alternatively, the screen may display pictures of a movie, music, etc. from another application stored in the mobile phone.

By monitoring the motions of the face in this manner, a pitch [bpm] (number of steps per minute) indicating the number of steps walked in unit time can be measured. When a length of stride is input in the mobile phone in advance, data of stride, speed, and distance can be measured. If the person walks a few steps in advance while carrying the mobile phone and calibration is performed using the number of steps obtained from a built-in motion sensor of the mobile phone, accuracy of measuring the number of steps would be improved.

In the following, the operation of the measuring apparatus 20 of the present embodiment illustrated in FIG. 2 will be described in detail by referring to the flowchart of FIG. 3. In FIG. 3, the person 30 first starts a motional state measurement application (program according to the present embodiment) of the mobile phone carried by the person 30. When the motional state measurement application is started (step S101), the control unit 21 confirms the completion of setting the in-camera (image pickup unit 23) by the person 30 (“YES” at step S102), and detects the pressing of a measurement button by the operating unit 25 (step S103). Confirmation of the completion of setting the in-camera is performed by the person 30 operating the operating unit 25 (to input YES or NO) in response to a message “Is setting of in-camera complete?” which is displayed on the display unit 26.

When the pressing of the measurement button is detected (“YES” at step S103), the control unit 21 (image acquiring unit 211) sequentially acquires images captured by the image pickup unit 23 and outputs the acquired images to the position detecting unit 212 (step S104). In response, the position detecting unit 212 detects the positions of the face of the person in the images having been sequentially acquired by the image acquiring unit 211, and outputs the detected positions to the measuring unit 213 (step S105). Based on the positions of the face of the person 30 in the images detected by the position detecting unit 212, the measuring unit 213 executes measurement processing of the motional state to measure a continuous motional state of the person 30 (step S106). In the measurement processing of the motional state, the current running or walking state can be displayed. Alternatively, it is also possible to use another application, for example, to reproduce a movie, etc. Specifically, upon receiving a request to start another application (“YES” at step S107), the control unit 21 executes switching to another application program such as an application to reproduce music or motion pictures (step S108).

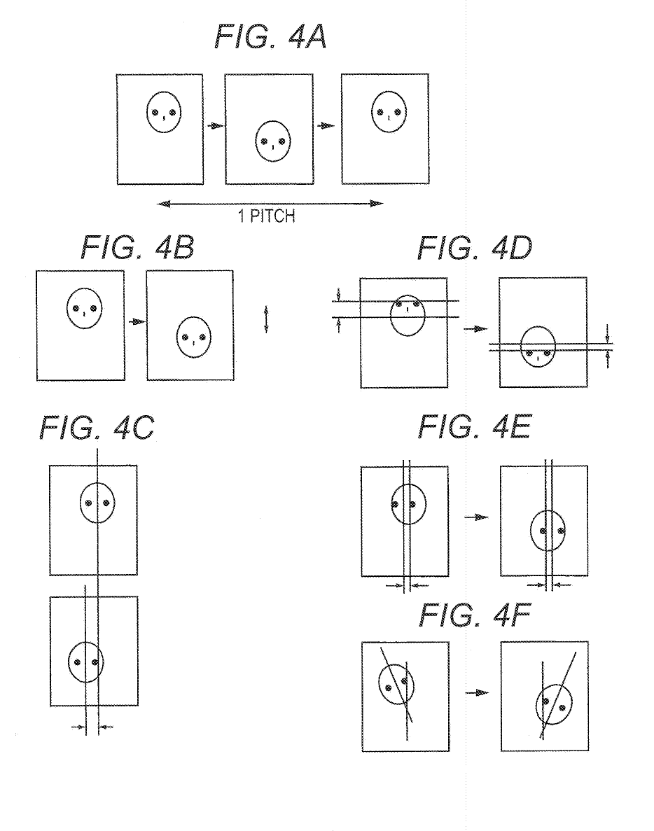

The measurement processing of the motional state (step S106) will be described in detail below. The measuring unit 213 measures the changes in positions of the face of the person 30 in the images detected by the position detecting unit 212 as a motional state. Specifically, as illustrated in FIG. 4A, the number of pitches of the person 30 is measured as a motional state according to a periodic vertical change in the positions of the face of the person 30 in the images. The measuring unit 213 performs measurement other than step number measurement. The principle of the step number measurement is illustrated in FIG. 4A. As described above, the number of steps can be measured by monitoring the periodic motion of the face. As an index to indicate whether the running or walking form is proper, a vertical deviation (FIG. 4B) and a horizontal deviation (FIG. 4C) are provided. These deviations can also be measured by the image processing (both in unit [cm]).

Motions to be measured also include rotational movement, for example, other than the parallel-type motions illustrated, Specifically, an inclination of the face caused by swinging the head, an angle of the vertical swing of the head (FIG. 4D), an angle of a lateral swing of the head (FIG. 4E), and a detected inclination of the head (FIG. 4F) can also be measured. Further, the motion in a front-back direction can be measured according to changes in a distance between characteristic points of the face being detected. Items to be measured that can be realized by image processing also include, in addition to other items, a change of color of the face, a breathing rate according to a change of the way a mouth is opened, and a movement of a line of sight. Detection of the movement of the line of sight has already been put into practical use. For example, when the inner corner of the eye is regarded as a reference point and an iris is regarded as a moving point, the movement of the eye can be detected based on the position of the iris relative to the corner of the eye.

The description continues by referring to the flowchart of FIG. 3 again. A result of measurement executed by the measuring unit 213 is displayed by detecting the pressing of an “output button” (“YES” at step S109) when the person 30 operates the operating unit 25. Specifically, when the output button is pressed and the motional state measurement application is started again, the display control unit 214 controls the display unit 26 to display the motional state that has been measured by the measuring unit 213 (step S110).

Examples of display of the measurement results are illustrated in FIGS. 5A and 5B. In displaying the measurement result, it may be possible to display an initial value or an average value. Alternatively, as illustrated in FIG. 5A and 5B, time sequence of the measurement result can be displayed on the time axis. Also, as illustrated in FIG. 5B, the quality of exercise can be improved by simultaneously displaying, as a comparative example, the measurement result of an expert who is regarded as a model. In the examples illustrated in FIGS. 5A and 5B, the pitch and the vertical movement have been displayed. It is also possible, however, to display the rotational movement as illustrated in FIGS. 4D, 4E and 4F and all values measured by the measuring apparatus 20, such as the above-mentioned color of the face and breathing rate.

As an alternative to the graphs illustrated in the drawings, the vertical and horizontal movements may be depicted by graphs. In this case, a graph for the person 30 may be displayed in comparison with a graph for an expert who is regarded as a model. This type of display may be implemented by the display control unit 214 superimposing respective display data generated by the control unit 21.

The distance calculating unit 215 may calculate, for example, a distance regarding walking or running of the person 30 according to a previously input stride and a measured pitch thereof. The display control unit 214 may control the display unit 26 to display the motional state corresponding to the running distance calculated by the distance calculating unit 215.

FIG. 6 illustrates another display example. Referring to FIG. 6, the control unit 21 evaluates items to be measured. For example, a marking result may be displayed along with the measurement data to inform the person 30 of the details of the motional state. Accordingly, the quality of exercise can be improved on and after the next exercise. The marking may be performed, for example, by the control unit 21 calculating divergence or variations relative to the vertical movement of an ideal person as an expert. Accordingly, a marking result is obtained by referring to a data table used for score evaluation and stored in the storage unit 22.

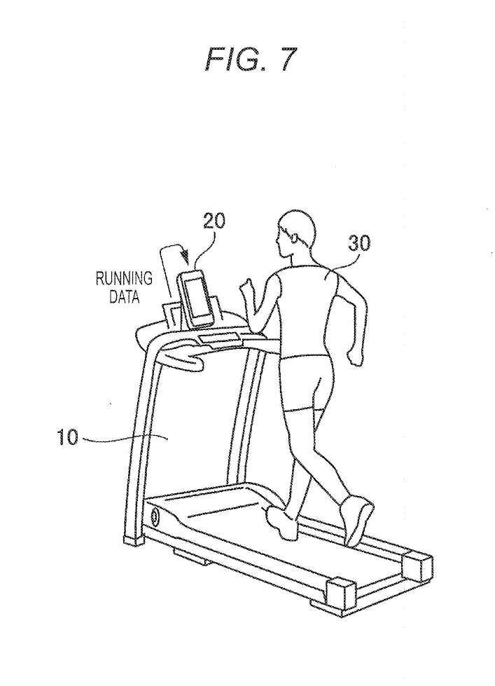

FIG. 7 is an explanatory view cited to explain a cooperative operation with the treadmill 10 to which the measuring apparatus 20 of the present embodiment is applied. According to FIG. 7, short-range wireless communication is performed between the measuring apparatus 20 and the treadmill 10 in order to enhance measurement items. The control unit 21 of the measuring apparatus 20 obtains, from the treadmill 10 via the communication unit 24, the items (e.g., running speed and distance, and an inclination angle) that have been measured by the treadmill 10. The measuring apparatus 20 then calibrates the own measured data to improve accuracy of the measurement items, while complementing the data to enhance the measurement items.

(Effect of the Embodiment)

As described above, in the measuring apparatus 20 according to the present embodiment, the control unit 21 sequentially acquires the images including the face of the person 30, and detects positions of the face of the person 30 in the acquired images. Meanwhile, the control unit 21 measures the continuous motional state of the person 30 based on the detected positions of the face of the person 30 in the images. Specifically, the in-camera of the mobile phone is used as the motional state measuring apparatus 20 to measure the pitch by detecting periodical movements of the face of the person 30. It may also be possible to additionally measure the vertical and horizontal movements of the face as well. By doing this, the continuous motional state of the person 30 can be measured properly even when the continuous movement may change due to fatigue, for example, of the person 30. By providing feedback on the measurement result to the person 30 by displaying the measurement result, the quality of exercise of the person 30 can be improved. The person 30 can exercise without wearing the mobile phone to measure the motional state. This prevents giving a burdensome feel to the person 30. The person 30 can exercise while enjoying the displayed content on the screen. It is also possible to measure other items (e.g. deviations and changes in vertical and horizontal directions, a color of the face, and the respiratory condition) that cannot be measured by the acceleration sensor alone. Measurement results of these items can be displayed and fed back to the runner to further improve the quality of the exercise.

Although the mobile phone has been described as an example of the measuring apparatus 20 of the present embodiment, the measuring apparatus is not limited thereto and may be applied to any mobile electronic device with a camera (image pickup unit 23), such as a tablet terminal, a PC, a mobile phone, or a personal digital assistance (PDA). Also, although the measuring apparatus 20 of the present embodiment has been applied to the treadmill 10, the present embodiment is applicable to any health appliance other than the treadmill 10. In S106 of FIG. 3, the measurement processing of the motional state is performed by detecting the face in S105, but the processing is not limited thereto. Specifically, the measurement of the motional state may be performed by edge detection to detect a shoulder line, for example, other than the detection of the face, to thereby measure the motional state according to a positional change of the shoulder line.

Although the preferred embodiment of the present invention has been described above, the technical field of the above-described embodiment is not limited thereto. It is obvious to a person having ordinary skills in the art that various changes and improvements can be added to the embodiment described above. It will also be apparent from the description of the scope of claims that such embodiments with the changes and improvements added can also be included in the technical field of the present invention.

What is claimed is:

1. A measuring apparatus, comprising:
an image acquiring unit configured to sequentially acquire images;
a position detecting unit configured to detect positions of a particular body part of a person in the images sequentially acquired by the image acquiring unit; and
a measuring unit configured to measure a continuous motional state of the person based on the detected positions of the particular body part.

2. The measuring apparatus according to claim 1, wherein
the measuring unit is configured to measure, as the motional state, change of the detected positions.

3. The measuring apparatus according to claim 2, wherein
the measuring unit is configured to measure, as the motional state, a pitch number of the person based on a periodic change in a vertical direction of the positions of the particular body part.

4. The measuring apparatus according to claim 2, wherein
the measuring unit is configured to measure, as a change of the motional state, a deviation in a horizontal direction of the particular body part.

5. The measuring apparatus according to claim 1, further comprising:
a display control unit configured to controls a display unit to display the motional state that has been measured by the measuring unit.

6. The measuring apparatus according to claim 5, further comprising:
a distance calculating unit configured to calculate a distance regarding walking or running of the person, wherein
the display control unit is configured to controls the display unit to display the motional state relating to the distance calculated by the distance calculating unit.

7. A method for measuring a continuous motional state of a person, comprising the steps of:
sequentially acquiring images;
detecting positions of a particular body part of the person in the sequentially acquired images; and
measuring the continuous motional state of the person based on the detected positions of the particular body part of the person.

8. A non-volatile recording medium storing a computer-readable program for causing a computer to execute:
a procedure to sequentially acquire images,
a procedure to detect positions of a particular body part of a person in the acquired images, and
a procedure to measure a continuous motional state of the person based on the detected positions of the particular body part.
